(19) United States
(12) Patent Application Publication
(10) Pub. No.: US 2010/0179881 A1
(43) Pub. Date: Jul. 15, 2010

(54) SYSTEM FOR MAKING PRODUCT PURCHASES

(76) Inventor: Ryan M. Wiederstein, Cumming, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/352,036

(22) Filed: Jan. 12, 2009

(51) Int. Cl. G06Q 30/00

(52) U.S. Cl. 705/26

(57) ABSTRACT

A system for making product purchases utilizing a website. The website is connected to an electronic network wherein the website has a controller and a database that contains information on recipes, products and a consumer's pantry. A remote computer is also provided in the system and is connected to the electronic network and keeps track of updated pantry information based upon consumption and purchase of products over time.

### BACKGROUND OF THE INVENTION

This invention relates to a system for making product purchases. More specifically this invention relates to a system that utilizes an electronic network to help individuals purchase food products and plan meals.

For many years individuals have struggled with obtaining the correct amount of food in their homes and coming up with grocery lists for meals that are going to be prepared on an everyday basis. Specifically, oftentimes individuals do not have time to sit down and think about the type of meals they want during the week, the ingredients that will be needed to prepare these desired meals and to determine whether or not the individual already has ingredients for those meals. Additionally individuals do not have time to see whether or not those food products have expired.

As a result of the lack of time needed to prepare a list of desired meals, ingredients and knowledge as to what food products an individual has many problems arise. These include not preparing a list of meals and eating out for meals on many occasions which cannot only be extremely expensive but additionally unhealthy. Other problems arise in that ingredients can be forgotten making the meal unsavory. Additionally individuals have a tendency to not realize that they don't have a certain ingredient that needs to be purchased or that they are low on an ingredient or food product that needs to be purchased to make a meal. This leaves the individual on the night that the meal is to be prepared left to either running to the store to pick up this ingredient or alternatively preparing a different meal which can include ordering take-out or delivery. Another problem exists in that oftentimes individuals do not believe they have a desired ingredient or food product when in fact they do have that food product. As a result an individual can end up with an overabundance of a certain food product or ingredient. This not only causes additional space and storage facilities to be taken but additionally in the case where a food product can expire and needs to be thrown out can cost the individual money that over time can become considerable. Therefore a need in the art exists for a product or system that allows an individual to quickly put together meal plans wherein the ingredients are easily accessible and the amount of ingredients and food product that need to be purchased is known.

Therefore a principal object of the present invention is to provide an improved system for making product purchases that reduces the time needed to make these purchases.

Yet another object of the present invention is to provide a system for making product purchases that minimizes the cost and waste when making purchases.

These and other objects, features or advantages of the present invention will become apparent from the specification and claims.

### BRIEF SUMMARY OF THE INVENTION

A system for making product purchases. The system includes a website that is connected to an electronic network wherein the website has a controller and a database containing information on recipes, products and a consumer's pantry. The system also includes a remote computer connected to the electronic network where the consumer pantry information in the website database is updated based upon consumption and purchase of a product. In this manner an individual can easily make meal choices and know the exact amount of food product that needs to be purchased when going to a store.

### BRIEF DESCRIPTION OF THE DRAWINGS

FIG. 1 is a schematic diagram of a system for making product purchase; and

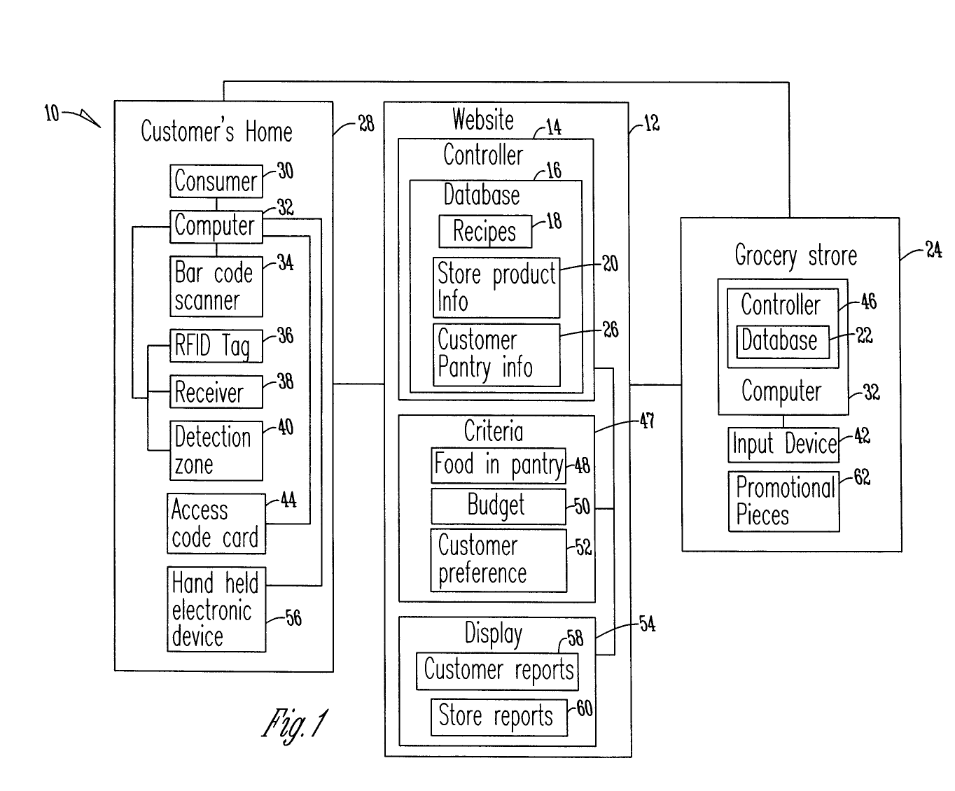

FIG. 2 is a flow chart of a method used for making product purchases using the system of FIG. 1.

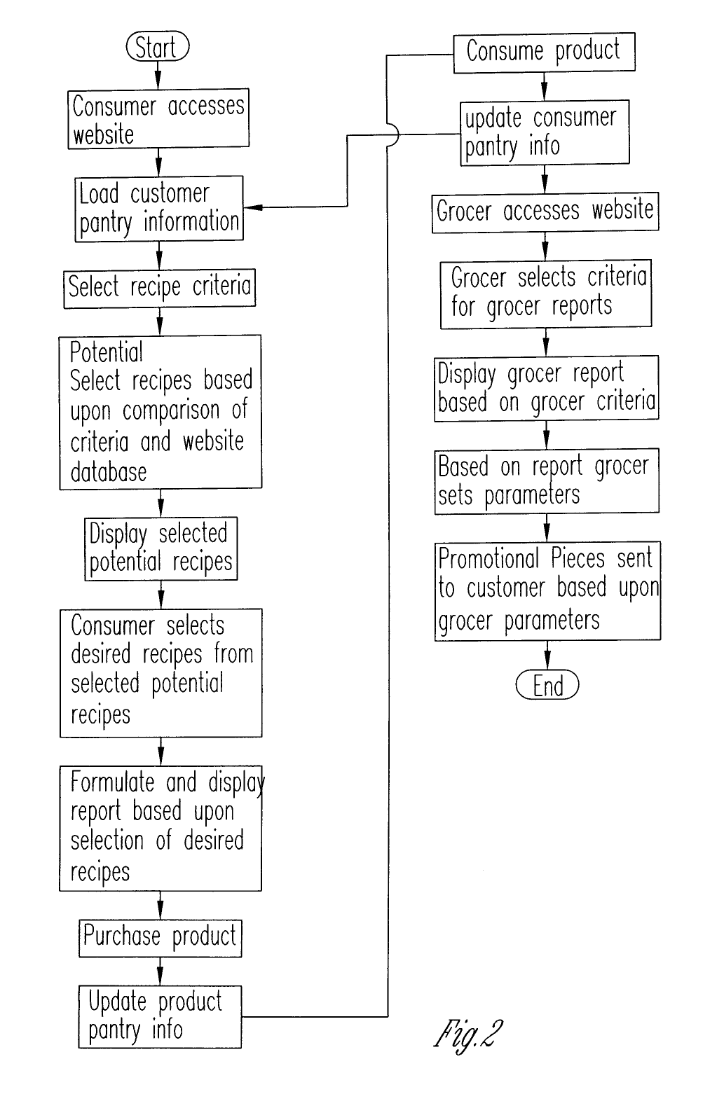

### DETAILED DESCRIPTION OF THE PREFERRED EMBODIMENT

The system and method 10 include a website 12 that is accessible over an electronic network. The website 12 is connected to a controller 14 having a database 16. The information contained on the database 16 falls into three primary areas or topics. The first topic area is recipes 18 which, as an example, includes files such as costs of ingredients pulled from a grocer or supplier's database, cooking time, preparation time, preparation difficulty, and recipe type. Recipe types would include information such as food type (i.e., beef, chicken, pork, fish, vegetable, fruit) meal types (i.e., breakfast, brunch, lunch, dinner, or snack) menu type(i.e., Italian, Mexican, French, American, Chinese, etc.) dish type (i.e., appetizer, salad, entree, side, or dessert) and nutritional type (i.e., low calorie, low fat, high protein, low sodium, or diabetic). The nutritional type could be determined by the ingredients nutritional value. For example, based on all of the ingredients nutritional information, the system could determine any requested nutritional value per serving. For instance, how much sodium per serving, etc. Certain recipe types may be selected as favorites and family recipes may be added to the database 16.

The second topic area is store product information 20. The information for store products 20, as an example, includes fields such as product identification number (UPC or other ID), store name, brand name, product name, location of product in store, nutritional information of product, product size, price, and green ratings may be cross referenced with a third party provider of such information. For instance, a third party may have given a green rating of 6 to a box of Wheat Thins on a scale of 1-10. Therefore, the UPC for that particular box of Wheat Thins relates directly to the green value of that same UPC determined by a third party. Preferably, this information is supplied to the database and periodically updated from information that is maintained within a store database 22 at a plurality of grocery stores 24 via a link on the electronic network. Alternatively, this information is manually input into the website database 16.

The third topic area for database 16 is information related to a consumer's pantry 26, refrigerator, freezer or other food product storage area. The information for the consumer's pantry 26, as an example, includes a UPC or UPC equivalent, product name, brand name, quantity, and expiration date and any other information that can be gathered by cross referencing the UPC. Consumer pantry information 26 is related to items not yet consumed at the consumer's home 28. This information may initially be inputted by a consumer 30 by accessing the website 12 via a computer 32, or electronically by the use of a scanner or RFID technology as will be explained. Consumer pantry information 26 is periodically updated either manually or electronically by the consumer 30 as products are purchased at the grocery store 24 or disposed of at the consumer's home 28. A consumer 30 may be required to update pantry information 26 prior to planning meals. The pantry information 26 is used for many purposes such as determining the dollar value of the food inventory or determining the amount consumed or disposed of over a selected period of time.

The consumer 30, as previously mentioned initially, may access the website 12 via a computer 32 and manually input information related to products in the consumer's pantry 26. Alternatively, the consumer uses a bar code scanner 34 to scan and record each item in the pantry and then uploads or inputs the recorded information to the website database 16 via the computer 32. Another option is to use radio-frequency identification technology (RFID) to track products in the consumer's pantry. In this embodiment, each product is given an RFID tag 36 or a chipless RFID tag that transmits a signal to a receiver 38. In this instance, the information is uploaded or input from the receiver 38 to the website database 16 via the computer 32, or the computer 32 is set up to receive the signal and automatically updates the database website 16 via the electronic network. This can be done wirelessly or by interfacing a low voltage cable directly to the device.

As the consumer 30 consumes or disposes of product, the consumer's pantry information 26 is updated. This is done manually by inputting information into the website database 16 using a computer 32 connected via an electronic network. Alternatively, as the consumer 30 uses a product, they scan the bar code with the scanner 34 and then subsequently they download information on used products to the website database 16 via the computer 32. In another embodiment, the product having the RFID tag 36 is removed from the area where a signal is detected (detection zone 40) by the receiver 38 and the website database 16 is subsequently updated either automatically via the computer 32 over the electronic network or by uploading the updated information from the receiver 38 to the computer 32 and then transmitting via the electronic network. The consumer's pantry information 26, upon the acquisition of product, is updated in a similar manner—either inputting information manually through the use of a bar code scanner 34, or through the presence of an RFID tag 36 within a detection zone 40.

Alternatively, the consumer's pantry information 26 is updated at the grocery store 24 at the time of purchase. Any means of identifying the customer as compared to the consumer's pantry information 26 may be used. In one example, the consumer 30 provides a personal access code in an input device 42 at the store 24 or by scanning the magnetic strip of an access code card 44. Once entered, as product is scanned by the clerk at the store 24, updated information is automatically transmitted from a store controller 46 to the website database 16 via an electronic network. In another example, as product is scanned by the store clerk, updated information is recorded on the access code card 44 or other memory device. Once the purchase is completed, the consumer 26 downloads the updated information from card 44 to computer 32 and then transmits the updated information from the computer 32 to the website database 16 via the electronic network.

In operation, the consumer 30 accesses the website 12 via computer 32. To plan menus and develop a grocery list, the consumer selects criteria 47 available on the website. An example of one criteria that a consumer may select is food in the pantry 48. By selecting this criteria, the controller 14 is prompted to compare items in the consumer's pantry information 26 with recipes that include products in the consumer's pantry from the database 16 to select recipes. Another example of a criteria 46 is budget 50. By selecting budget 50 as a criteria 47, the consumer 30 identifies a dollar amount the consumer 30 wishes to spend over a specific time period. The consumer may set a dollar amount for each meal or for a specific time period, such as a day, week, or month. Upon selecting budget criteria, the controller 14 is prompted to compare the cost of ingredients with recipes in the database 16 to select recipes that meet the budget criteria to select recipes.

Another example of a criteria 47, is consumer preferences 52. Consumer preferences include cooking time, preparation time, preparation difficulty, recipe type, and store name. Upon selecting a consumer preference criteria 52, the controller compares the various selected preferences with various recipes 18 in the database 16 to select recipes that meet the selected preferences. The consumer 30 may also prioritize multiple criteria selections and/or request only recipes that have all the selected criteria or select a specific number of recipes that have the most selected criteria items.

Once the controller 14 has selected recipes based upon the consumer's criteria 47, a list of the recipes are displayed on the website 12. The consumer 30 then selects desired recipes. Either the consumer 30 will select a desired number of recipes, or the consumer will select and schedule recipes for certain days and time periods.

Once the consumer 30 has completed the selection of recipes, the controller 14 is prompted to formulate and display 54 a shopping list of the ingredients and quantity of each recipe from the database 16 that is displayed on the website 12. On example of the display 54 organizes the products by store name and location of product in the store, and lists the products by brand name, quantity, and price. The display 54 may be printed by the consumer 30 or downloaded to a hand-held electronic device 56, submitted to an online grocery store delivery system or the like.

As an example, a consumer 30 has 2 ounces of peanut butter in their fridge (i.e., the jar of peanut butter purchased 3 weeks ago for $2.50 has 10 ounces). The consumer estimates the remaining amount during an inventory update exercise and determines they have ¼ of a jar left. The controller 14 then calculates the estimated amount of peanut butter remaining and its value of $0.63. The recipe 18 calls for peanut butter, strawberry jelly and 2 slices of bread per serving. The controller 14 asks how many people the consumer is trying to feed and the consumer 30 inputs 4. The controller 14 asks if the consumer 30 would like to prepare more than one meal, which may optimize the spending and leftover food. Consumer 30 inputs: no. Consumer updates bread quantity by 2 slices.

The controller 14 then calculates that only 6 ounces of peanut butter is required, 8 ounces of strawberry jelly and 6 slices of bread. The controller 14 may suggest an alternative of grape jelly due to it being on sale and specific bread that may be more appealing due to a special sale or advises that a coupon is available which can be printed by the consumer 30. Based on the inputted information that has been compared to information in the database the controller 14 selects and displays on the website 12 the following display 54.

### Option 1:

Jiff Peanut Butter—Total amount of Jar 12 Ounces $3.50
Smuckers Jelly—Strawberry—14 ounces $5.50
Brand Y bread—approximately 15 slices of bread—$3.50
Total Cost of this purchase—$12.50
Cost per serving for items purchased: $3.125
Estimate value of remaining product after preparation and consumption:
Jelly—$2.35
Peanut Butter—(used existing first)—$1.75
Bread—(used existing first)—$1.63
Total Remainder that you will have yet to consume: $5.73.

### Option 2:

Generic Peanut Butter—Total Amount of Jar 10 Ounces $3.25
Generic Jelly—Strawberry—10 ounces $4.50
Brand Y bread—approximately 12 slices of bread—$3.00
Total Cost of this purchase—410.75
Cost per serving for items purchased: $2.6875
Estimate value of remaining product after preparation and consumption:
Jelly—$0.90
Peanut Butter—(used existing first)—$1.30
Bread—(used existing first)—$1.50
Total Remainder that you will have yet to consume: $3.70

The controller 14 would also recommend purchasing a larger quantity at a better price and recommend other recipes that would help consume items in home inventory, thus reducing the amount that can go to waste.

The consumer 30 then goes to the store 24 with the list and selects products. As the consumer 30 checks out, the consumer's pantry information 26 is updated as previously described. Also, as the consumer 30 uses or disposes of product, the consumer pantry information 26 is updated as previously described. The controller 14 periodically checks the quantities and expiration dates of products in the consumer's pantry information 26 and sends notices either by e-mail or posting on the website 12 that the consumer is running low on an item or that an expiration date is nearing. The consumer, through the website 12, can set parameters for how often and how far in advance parameters are given.

The grocer 24 also uses the information in the database 16. The grocer 24 access the website 12 through a computer 32 connected to an electronic network through a secured portal. The grocer selects from a menu of reports 58, which prompt the controller 14 to gather information from the database 16 and then organize and display 60 the information. Examples of reports include individual and group buying patterns that identify product purchased, frequency of visits, day of week, and time of day; individual and group pantry information that identify quantity and expiration dates, and consumer preferences that identify both individual and group criteria that is selected. From these reports, which are printable and downloadable, the grocer prepares promotional pieces 62 that are sent to the consumer 30 either through posting on the website, through an e-mail, or conventional mail. Based on parameters set by the grocer 24, the controller 14 is prompted to send promotional notices 62 to the consumer 30. For example, if the consumer is running low on milk, the controller 14 detects this and sends a notice to the consumer 30 that milk is on sale. If the consumer had demonstrated a preference for Mexican food, the controller 14 is prompted to send a promotional notice 62 advertising new Mexican food products. In setting the parameters, the grocer 24 selects the triggering information, the content of the promotional piece 62, and the frequency.

Accordingly, a system and method have been described that, at the very least, meet the stated objectives.

1. A system for making product purchases, comprising:
a website connected to an electronic network, the website having a controller and a database containing information on recipes, products, and a consumer's pantry; and
a remote computer connected to the electronic network where the consumer pantry information in the website database is updated based upon consumption and purchase of a product;
wherein the information on products is supplied to the database and updated by communication with a store database at a plurality of grocery stores via a link on the electronic network.

2. The system of claim 1 wherein the information on recipes includes information relating to one of the group consisting of food type, meal type, dish type and nutritional type.

3. The system of claim 2 wherein the food type is selected from one of the group consisting of beef, chicken, pork, fish, vegetable and fruit.

4. The system of claim 2 wherein the meal type is selected from one of the group consisting of breakfast, brunch, lunch, dinner and snack.

5. The system of claim 2 wherein the menu type is selected from one of the group consisting of Italian, Mexican, French, American and Chinese.

6. The system of claim 2 wherein the dish type is selected from one of the group consisting of appetizer, salad, entree, side and dessert.

7. The system of claim 2 wherein the nutritional type is selected from one of the group consisting of low calorie, low fat, high protein, low sodium, and diabetic.

8. The system of claim 1 wherein the information on products includes information on one of the group consisting of product identification number, store name, brand name, product name, location of product in store, nutritional information of product, product size, product price, and green rating.

9. (canceled)

10. The system of claim 1 wherein the information on the consumer's pantry includes information related to a food product storage area.

11. The system of claim 10 wherein the information on one of the group consisting of the consumer's pantry includes UPC, product name, brand name, quantity of product, and expiration date.

12. The system of claim 1 wherein the consumer pantry information is updated manually by a consumer via a website on a computer.

13. The system of claim 1 wherein the consumer pantry information is updated electronically by one of the group consisting of a scanner or RFID.

14. The system of claim 1 wherein the consumer pantry information is updated at the time of purchase.

15. The system of claim 14 wherein the consumer pantry information is updated with a handheld input device that uses a personal access code.

16. The system of claim 15 wherein information is downloaded from the handheld input device to the remote computer to update the consumer pantry information.

17. The system of claim 1 wherein the remote computer notifies the consumer when a product needs to be replaced.

18. The system of claim 1 wherein the remote computer suggests products to buy based upon the consumption and purchase of products.
